(19) United States
(12) Patent Application Publication
(10) Pub. No.: US 2026/0301107 A1
(43) Pub. Date: Oct. 1, 2026

(54) INTEGRATED ARTIFICIAL INTELLIGENCE ENGINE AND GRAPHICS PROCESSING UNIT

(71) Applicant: XILINX, INC., San Jose, CA (US)

(72) Inventors: Juan J. NOGUERA SERRA, San Jose, CA (US); Javier CABEZAS RODRIGUEZ, Austin, TX (US); Sneha Bhalchandra DATE, San Jose, CA (US); Alejandro RICO CARRO, Austin, TX (US)

(21) Appl. No.: 19/091,516

(22) Filed: Mar. 26, 2025

(51) Int. Cl. G06T 1/20; G06T 15/00

(52) U.S. Cl. CPC G06T 1/20; G06T 15/005

(57) ABSTRACT

An integrated circuit (IC) device having an integrated artificial-intelligence engine (AIE) and a graphics processing unit (GPU), including an array of data processing elements (DPEs), a network of links/switches, and a compute unit (CU) of a shader engine that interfaces with the DPEs via the network. The CU may include single-instruction multiple-data (SIMD) processors, a local data storage system (LDS), and synchronizer circuitry that controls access to the LDS by the SIMD processors and the DPEs. The shader engine may include multiple compute units, each associated with a respective subset of the DPEs. IC device may include multiple shader engines, each having multiple compute units, each compute unit associated with a respective subset of the DPEs. The SIMD processors may exchange data with the DPEs via the LDS. The CU may exchange data with other CUs of the shader engine, and/or with CUs of other shader engines, via the network.

### TECHNICAL FIELD

Examples of the present disclosure generally relate to an integrated artificial intelligence engine (AIE) and graphics processing unit (GPU).

### BACKGROUND

In computer graphics, a shader determines appropriate levels of light, darkness, and color, when rendering a 3-dimensional scene for 2-dimensional presentation. Shaders have evolved to perform a variety of specialized functions in computer graphics special effects and video post-processing, as well as general-purpose computing on graphics processing units (GPUs).

### SUMMARY

Techniques for integrating an artificial intelligence engine (AIE) and a graphics processing unit (GPU) are described. One example is an integrated circuit (IC) device that includes a data processing array having data processing elements (DPEs) and a network of links and configurable switches. The IC device further includes a compute unit that interfaces with a subset of the DPEs via the network of links and switches, where the compute unit includes a set of single-instruction multiple-data (SIMD) processors, a local data storage system (LDS), and synchronizing circuitry that controls access to the LDS by the SIMD processors and the subset of the DPEs.

Another example is a shader engine (SE) that includes an array of data processing elements (DPEs), a network of links and configurable switches, and a compute unit that interface with a first subset of the DPEs, where the compute unit includes a set of single-instruction multiple-data (SIMD) processors, a local data storage system (LDS), and synchronizing circuitry that controls access to the LDS by the SIMD processors and the subset of the DPEs.

Another example is a graphics processing unit (GPU) that includes multiple integrated circuit dies, each having an array of data processing elements (DPEs) and first and second sets of compute units (CUs), where the first set of CUs interface with respective subsets of the DPEs as a first shader engine, and the second set of CUs interface with respective subsets of the DPEs as a second shader engine. The CUs may each include multiple single-instruction multiple-data (SIMD) processors, a local data storage system (LDS), and synchronizing circuitry that controls access to the LDS by the SIMD processors and the respective subset of the DPEs.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts an integrated circuit (IC) device that includes a shader engine (SE) and an array of data processing elements (DPEs), according to an embodiment.

FIG. 2 depicts the IC device according to another embodiment.

FIG. 3 depicts the IC device according to another embodiment.

FIG. 4 depicts a processing unit (PU) that includes a compute unit of the shader engine and a subset of the DPEs, according to an embodiment.

FIG. 5 depicts a portion of the IC device, according to an embodiment.

FIG. 6 depicts the IC device including multiple IC dies, according to an embodiment.

FIG. 7 depicts a portion of the array according to an embodiment.

FIG. 8 depicts a portion of the array according to a further embodiment.

FIG. 9 depicts a portion of the array according to a further embodiment.

FIG. 10 depicts a system in which the array and the shader engine are integrated within a graphics processing unit (GPU), according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe integrated an artificial intelligence engines (AIEs) and graphics processing units (GPUs).

In computer graphics, a shader is a computer program that calculates the appropriate levels of light, darkness, and color during the rendering of a 3D scene—a process known as shading. Shaders have evolved to perform a variety of specialized functions in computer graphics special effects and video post-processing, as well as general-purpose computing on graphics processing units. Shaders include vertex shaders and pixel shaders. Vertex shaders describe attributes (e.g., position, texture coordinates, colors, and/or other features) of a vertex. Pixel shaders describe traits (e.g., color, z-depth, and alpha value) of a pixel.

GPUs process extensive amounts of image data in parallel, often applying the same instructions/processes in each parallel branch. A brief description of a graphics processing pipeline is described below. A host device sends instructions (e.g., a compiled shading application program) and geometry data to the GPU. A vertex shader of the GPU transforms the data. If the GPU includes a geometry shader, the geometry shader may alter geometries of a scene. If the GPU includes a tessellation shader, the tessellation shader may subdivide the geometries in the scene. The tessellation shader may triangulate the geometries (i.e., subdivide the geometries into triangles). A fragment shader may fragment the triangles into fragment quads, modify the quads, and perform a depth tests. Fragments that pass the depth test may be selected for presentation (e.g., rendered on a display and/or blended into a frame buffer).

Graphics processing is computationally expensive, especially for first-person computer games/simulations in which a player is free to constantly change their location and viewpoint.

Integrating artificial intelligence engines (AIEs) with a shader engine of a GPU may increase data throughput, provide configurability, and expand the types/numbers of computational processes performed by a GPU. Integrating artificial intelligence engines (AIEs) with a shader engine of a GPU may also expand applications of AI in graphics processing.

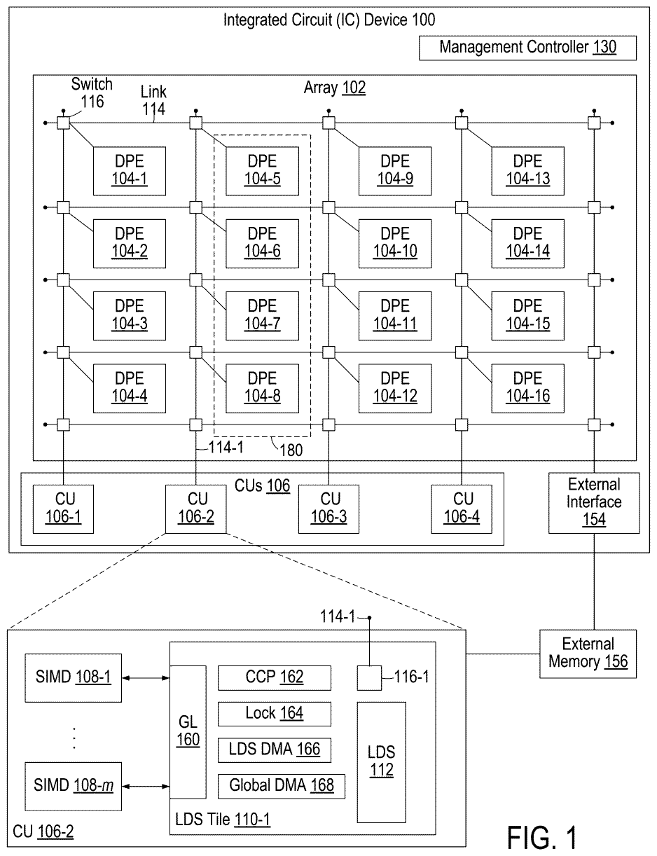

FIG. 1 depicts an integrated circuit (IC) device 100, according to an embodiment. IC device 100 includes one or more compute units (CUs), depicted here as CUs 106-1 through 106-4 (collectively, CUs 106). IC device 100 further includes an array 102 of data processing elements (DPEs) 104-1 through 104-16 (collectively, DPEs 104). IC device 100 further includes an interconnect network that includes links 114 and switches 116. Switches 116 may be configurable and may be incorporated within DPEs 104 and CUs 106, examples of which are provided further below. IC device 100 may further include an external interface circuit 154 to interface with one or more external devices, such as an external memory 156. IC device 100 may further include a management controller 130 to manage features of array 102 and/or CUs 106, such as to provide configuration bits, which are described further below. IC device 100 may include one or more IC dies and/or a printed circuit board.

DPEs 104, or a subset thereof, may be substantially identical to one another. Alternatively, DPEs 104, or a subset thereof, may differ from one another. DPEs 104, or a subset thereof, may include instruction processors and memory. Alternatively, or additionally, DPEs 104, or a subset thereof, may be implemented with logic (e.g., combinational and/or sequential logic), with or without an instruction processor. In the example of FIG. 1, array 102 includes 16 DPEs 104. In other examples, array 102 may include more than 16 DPEs or fewer than 16 DPEs.

One or more DPEs 104 may be implemented or customized for a particular application. Customization may include compiling an application program specifically for DPEs 104. In an example, one or more DPEs 104 is implemented or customized for artificial intelligence (AI) applications (i.e., machine learning applications). Such DPEs may be referred to as artificial intelligence engines (AIEs). Alternatively, or additionally, one or more DPEs 104 may be implemented or customized for wireless applications, forward error correction applications, and/or other applications.

In the example of FIG. 1, CU 106-2 includes single-instruction multiple-data (SIMD) processors 108-1 through 108-m (collectively, SIMD processors 108). CU 106-2 further includes local data storage (LDS) tile 110-1 that includes local data memory, depicted here as LDS 112. LDS tile 110-1 further includes synchronizer circuitry, depicted here as a lock 164, to control access to LDS 112 by SIMD processors 108 and DPEs 104, or a subset thereof.

Further in the example of FIG. 1, CU 106-2 is associated with a set of DPEs, depicted here as a column 180 of DPEs 104-2, 104-3, 104-4, and 104-5. In this example, LDS 112 is accessible to SIMD processors 108 and DPEs 104-1 through 104-4. Remaining CUs 106 may be associated with respective groups of DPEs 104. In this example, CUs 106 and the associated DPEs 104 may represent or serve as a shader engine (SE).

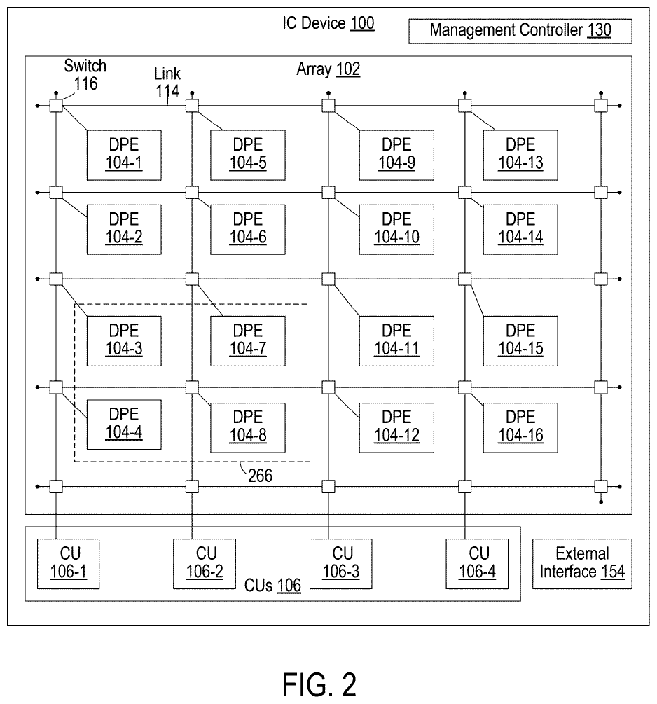

FIG. 2 depicts IC device 100 according to another embodiment. In the example of FIG. 2, CU 106-2 is associated with a block 266 of DPEs, including DPEs 104-3, 104-4, 104-7, and 104-8. In this example, LDS 112 is accessible to SIMD processors 108 and DPEs 104-3, 104-4, 104-7, and 104-8. Column 180 and/or block 266 may include more than 4 DPEs or fewer than 4 DPEs.

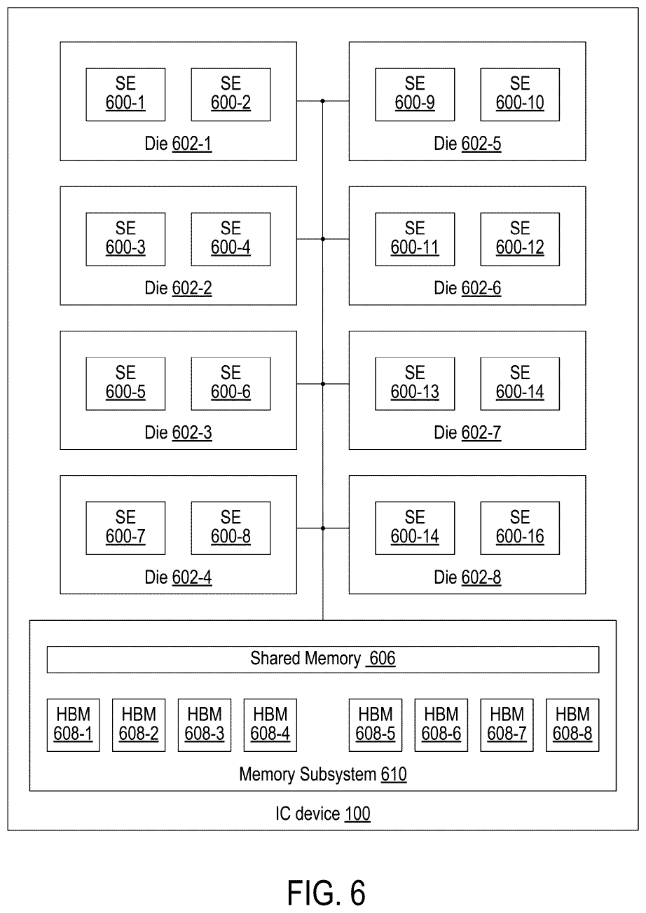

LDS tile 110-1 may further include a local interface circuit, depicted here as a switch 116-1 that connects to array 102 via a link 114-1. Switch 116-1 may include a stream switch and/or a memory-mapped switch, such as described further below. Alternatively, or additionally, switch 116-1 may represent a connection to a switch 116 of array 102. LDS tile 110-1 may further include synchronizer circuitry, depicted here as a lock 164, to permit SIMD processors 108 and the associated set of DPEs 104 to access LDS 112. LDS tile 110-1 may further include a global interface circuit GL 160 to interface with one or more other circuits/devices, such as a memory subsystem, an example of which is provided further below with reference to FIG. 6.

LDS tile 110-1 may further include a local direct-memory access engine (DMA), depicted here as a LDS DMA engine 166, to interface with DMA engines of the associated set of DPEs 104. LDS tile 110-1 may further include a global DMA engine 168 to interface with DMA engines of other circuits/devices. Global DMA engine 168 may be useful to move data from external memory 156 to LDS 112. LDS DMA engine 166 may be useful to move the data from LDS 112 to the associated DPEs 104. LDS tile 110-1 may further include a cache coherency protocol (CCP) circuit 162. Other CUs 106 may be similar or identical to CU 106-2.

DPEs 104 may include respective local data memory, which may be accessible to other DPEs 104 and/or to CU 106-2. DPEs 104 may exchange data and/or instructions with one another via the local data memories. Alternatively, or additionally, SIMD processors 108 may exchange data and/or instructions with the associated DPEs via LDS 112 and the local data memories of the associated DPEs. In addition, CUs 106 may exchange data and/or instructions with one another and/or with CUs of other SEs, via array 102.

In an example, a host device offloads tasks to a graphics processing unit (GPU), the GPU assigns shader tasks to CUs 106 for execution by SIMD processors 108, and CUs 106 offload aspects of the tasks to array 102. In this example, CUs 106 (i.e., SIMD processors 108) may provide data and/or instructions to the associated subset of DPEs 104 via LDS 112, and the subset of the DPEs 104 may return results to SIMD processors 108 via LDS 112.

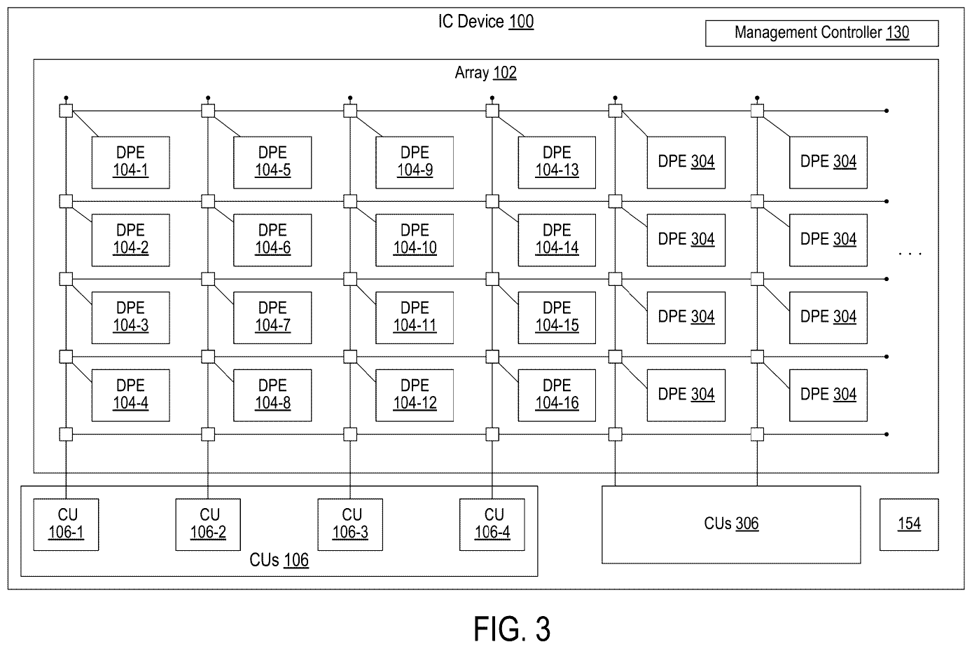

FIG. 3 depicts IC device 100 according to another embodiment. In the example of FIG. 3, IC device 100 includes one or more additional sets of CUs, depicted here as CUs 307. CUs 307 may be associated with respective groups of DPEs 304. CUs 307 and the associated groups of DPEs 304 may represent or serve as another SE.

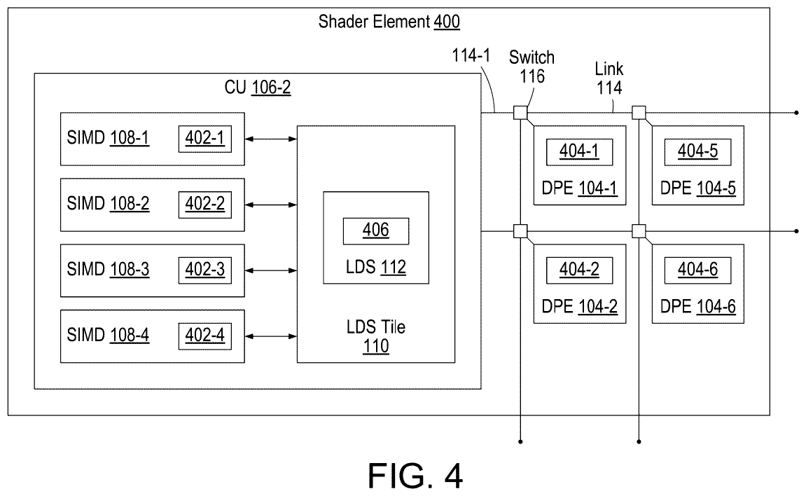

FIG. 4 depicts a shader element 400 that includes CU 106-2 and associated DPEs 104-1, 104-2, 104-5, and 104-6, according to an embodiment. In the example of FIG. 4, SIMD processors 108 include respective registers 402-1, 402-2, 402-3, and 402-4 (collectively, registers 402). Registers 402 may serve as GPU register files. Further in FIG. 4, DPEs 104-1, 104-2, 104-5, and 104-6 include respective local data memories 404-1, 404-2, 404-5, and 404-6 (collectively, local data memories 404). Portions of local data memories 404 may serve as registers, similar to registers 402. A portion of LDS 112 may also serve as registers 406.

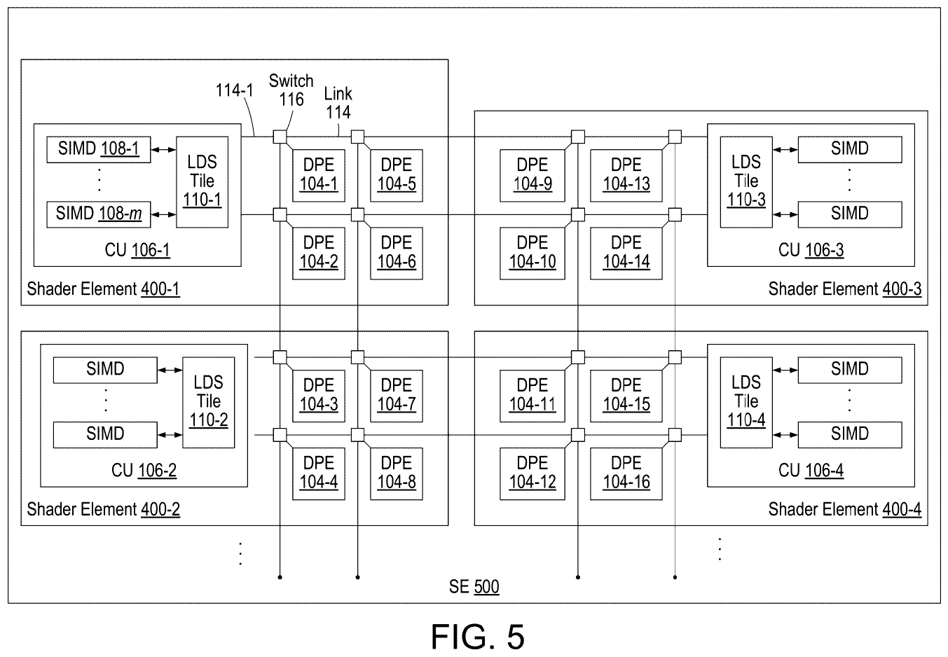

FIG. 5 depicts a SE 500, according to an embodiment. In the example of FIG. 5, SE 500 includes multiple shader elements, 400-1 through 300-4. Shader engines are not, however, limited to four shader elements, and shader elements are not limited to four DPEs.

FIG. 6 depicts IC device 100 according to another embodiment. In the example of FIG. 6, features of IC device 100 are arranged as SEs 660-1 through 600-16 (collectively, SEs 600). SEs 600 may be similar to SE 500 in FIG. 5. In FIG. 6, SEs 600 are placed on IC dies 602-1 through 602-8 (collectively, dies 602), two SEs per die. Dies 602 may be arranged as a 3-dimensional die stack, or as a 2.5 dimensional array (e.g., interconnected via a base die or an interposer). In FIG. 6, IC device 100 may further include a memory subsystem 610, which may include shared memory 606 (e.g., 128 Mbytes) and/or a high-bandwidth memory (HBM), depicted here as HBM memory modules 608-1 through 608-8 (collectively, HBM 608). HBM memory modules 608-1 through 608-8 may be dedicated to respective IC dies 602, or may be shared amongst IC dies 602.

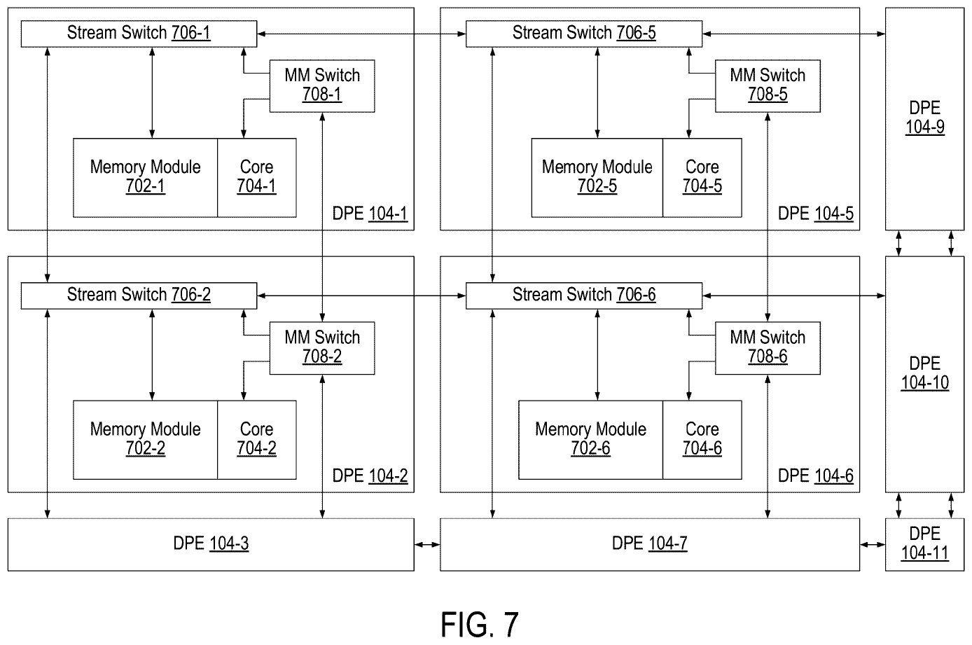

FIG. 7 depicts a portion of array 102, according to an embodiment. In the example of FIG. 7, DPE 104-1 includes a memory module 702-1, a core 704-1, a stream switch 706-1, and a memory mapped (MM) switch 708-1. DPE 104-2 includes a memory module 702-2, a core 704-2, a stream switch 706-2, and a MM switch 708-2. DPE 104-5 includes a memory module 702-5, a core 704-5, a stream switch 706-5, and a MM switch 708-5. DPE 104-6 includes a memory module 702-6, a core 704-6, a stream switch 706-6, and a MM switch 708-6. In FIG. 1, and switches 116 may include stream switches 706 and MM switches 708.

Stream switches 706 may provide communications within DPEs 104, amongst DPEs 104, and/or with other systems, circuits, and/or devices, such as CUs 106. Stream switches 706 may be configurable to connect with selected components of IC device 100. Stream switches 706 may be configurable/programmable to form clusters of DPEs 104 that exchange data, such as application data generated and/or operated on during runtime.

Stream switches 706 may be configurable to operate as a circuit-switching stream interconnect or a packet-switched stream interconnect. A circuit-switching stream interconnect may serve as a point-to-point communication channel, which may be dedicated to high-bandwidth communications among DPEs 104. A packet-switching stream interconnect may serve as a shared (e.g., time-multiplexed) communication channel for medium-bandwidth data streams. Stream switches 706 may be configurable/programmable to establish connections amongst DPEs 104, or subsets thereof.

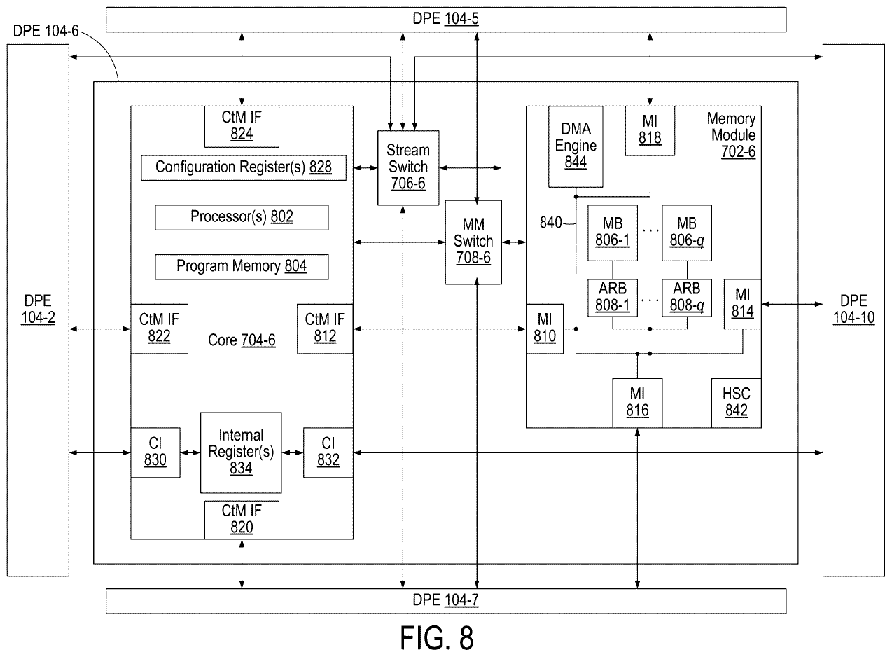

MM switches 708 may form a memory-mapped network in which MM switches 708 dynamically route transactions based on addresses. The memory-mapped network may also be referred to as a transaction-switched network. The memory-mapped network may be used to communicate data, commands, and/or bits for configuration, control, and/or debugging. The memory mapped network may have access to all storage elements (e.g., memory, registers, latches, and/or other storage elements) of array 102 and/or CUs 106, or a subset thereof. MM switches 708 may permit other circuits/devices to access resources of array 102. In an example, array 102 is mapped to an address space of management controller 130, to permit management controller 130 to access storage elements of DPEs 104 and/or CUs 106. Management controller 130 may use the memory-mapped network to provide configuration bits, such as described below with reference to FIG. 8.

FIG. 8 depicts a portion of array 102, according to a further embodiment. In the example of FIG. 8, core 704-6 of DPE 104-6 includes an instruction processor(s) 802, and program memory 804 that stores instructions for execution by processor(s) 802. The instructions may be provided by management controller 130. Processor(s) 802 may include, for example and without imitation, a central processing unit (CPU,) a graphics processing unit (GPU), a digital signal processor (DSP), a vector processor, a very long instruction word (VLIW) vector processor, and/or other type(s) of processor(s). Alternatively, or additionally, one or more DPEs 104 may be implemented with hardware-based logic (e.g., combinational logic and/or sequential logic). Alternatively, or additionally, one or more processor(s) 802 may include customized architecture to support an application-specific instruction set.

Core 704-6 may further include cascade interfaces (CIs) that provide direct communications with adjacent DPEs. In the example of FIG. 8, core 704-6 includes CIs 830 and 832 that interface with DPEs 104-2 and 104-10. In an example, CI 830 serves as an input CI, and CI 832 serves as an output CI. In this example, CI 830 may receive an input data stream from DPE 104-2, and may provide the data stream to processor(s) 802 and/or to CI 832, which may forward the data stream to DPE 104-10. CIs 830 and 832 may convey multi-bit data streams (e.g., tens or hundreds of bits in width). CIs 830 and 832 may include first-in-first-out (FIFO) buffers. CIs 830 and 832 may be controlled by processor(s) 802. In an example, processor(s) 802 may execute instructions to read from and/or write to CI 830 and/or CI 832. Alternatively, or additionally, core 704-6 may include hardwired logic to read from and/or write to CI 830 and/or CI 832. Alternatively, or additionally, CI 830 and/or CI 832 may be controlled by management controller 130 and/or another device.

Core 704-6 may further include an internal register(s) 834. Internal register(s) 834 may store data received via CI 830, and/or data generated and/or operated on by processor(s) 802. Internal register(s) 834 may include an accumulation register that stores intermediate results of operations performed by processor(s) 802. An accumulation register may be useful to free processor(s) 802 from writing intermediate results to memory module 702-6 and/or other memory device, which may save time and/or resources. Internal register(s) 834 may further include an additional register(s) that receives data via CI 830. In this example, CI 830 may write the received data to the additional register and/or may output the received data via CI 832 in a cascaded fashion. CIs 830 and 832 may transfer data on each clock cycle. CIs 830 and 832 may cascade internal register(s) 834 with internal register(s) of other DPEs 104.

Core 704-6 may further include a core-to-memory (CtM) interface 812 to permit core 704-6 to access memory module 702-6. Core 704-6 may further include CtM interfaces 820, 822, and 824, to access memory modules of adjacent DPEs 104-2, 104-5, and 104-7. Core 704-6 may map/route read and/or write operations through CtM interface 812, CtM interface 822, CI 830, and/or CI 832, based on addresses of the respective operations. Core 704-6 may decode addresses of received data to determine forwarding destinations of the received data, and/or may assign addresses to data generated by core 704-6 based on intended destinations of the generated data.

Core 704-6 may further include configuration random-access memory (CRAM), depicted here as configuration registers 828, which management controller 130 may load with configuration bits (e.g., via MM switch 708-6) to control functions/operations of DPE 104-6. Configuration registers 828 may be addressable via the memory mapped network of MM switches. Configuration registers 828 may control, for example and without limitation, configuration of core 704-6, configuration of memory module 702-6, configuration of stream switch 706-6, configuration of CtM interfaces 812, 820, 822, and 824, and/or configuration of CIs 830 and 832.

Configuration registers 828 may, for example, determine whether CIs 830 and 832 are enabled or disabled, enable selected ports of stream switch 706-6, configure stream switch 706-6 for packet-switched operation or circuit-switched operation. Configuration registers 828 may enable or disable DPE 104-6, or portions thereof. Configuration registers 828 may enable or disable memory module 702-6. In an example, configuration registers 828 may disable core 704-6 and enable memory module 702-6, such that memory module 702-6 is accessible to one or more other DPEs and/or CUs 106.

In the example of FIG. 8, memory module 702-6 includes one or more banks of memory and associated arbitration logic, depicted here as memory banks (MBs) 806-1 through 806-q, and arbitration logic (ARB) 808-1 through 808-q. ARBs 808 may include crossbars to permit writing to selectable ones of MBs 806. MBs 806 may represent an example of local data memories 404 in FIG. 4.

Memory module 702-6 further includes a memory interface (MI) 810 that permits core 704-6 to access MBs 806 via CtM interface 812. Memory module 702-6 may further include MIs 814, 816, and 818 to permit cores of adjacent DPEs 104-10, 104-7, and 104-5 to access MBs 806 via CtM interfaces of DPEs 104-10, 104-7, and 104-5.

Memory module 702-6 may further include a stream interface (not shown) that interfaces with stream switch 706-6, to permit other DPEs (e.g., non-adjacent DPEs) of array 102 to access MBs 806 via stream switch 706-6.

Memory module 702-6 may further include a direct-memory access (DMA) engine 844. DMA engine 844 may include one or more interfaces to receive data streams from other DPEs, write the received data to MBs 806, read data from MBs 806, and/or send data to other DPEs, via stream switch 306.

Memory module 702-6 may further include a memory mapped interface (not shown) that interfaces with MM switch 708-6.

Memory module 702-6 may further include a communication network 840 to provide communications amongst elements/components of memory module 702-6.

Memory module 702-6 may further include hardware synchronization circuitry (HSC) 842 that synchronizes operations of elements/circuits that access MBs 806 (e.g., core 704-6, cores of other DPEs 104, DME engine 844, management controller 130, and/or other circuits/devices).

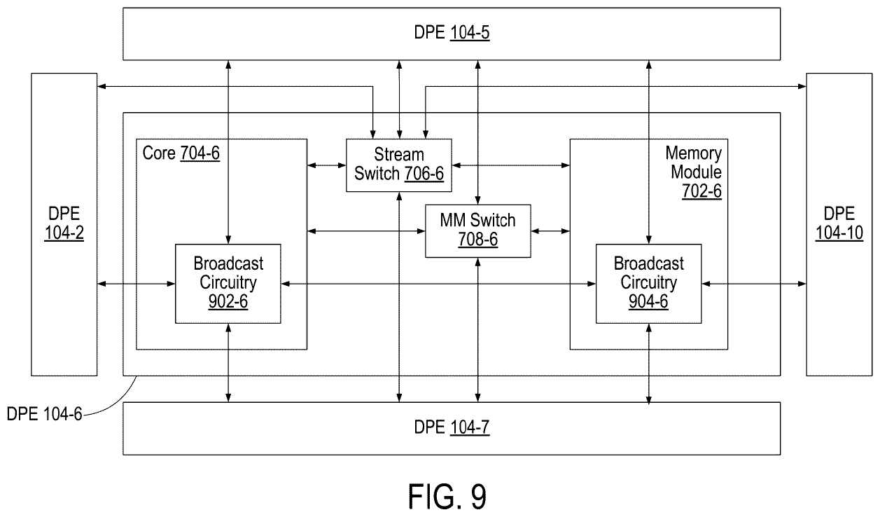

One or more DPEs 104 may further include broadcast circuitry, such as described below with reference to FIG. 9. FIG. 9 depicts a portion of array 102, according to a further embodiment. In the example of FIG. 9, core 706-4 includes broadcast circuitry 902-6, and memory module 702-6 includes broadcast circuitry 904-6. In other examples, broadcast circuitry 902-6 or broadcast circuitry 904-6 may be omitted. Broadcast circuitry 902-6 and/or broadcast circuitry 904-6 may be connected to broadcast circuitry of other DPEs 104, such as depicted in FIG. 9, and/or to one or more CUs 106. Broadcast circuitry of multiple DPEs 104 may form a broadcast network, which may be independent of other communication channels of IC device 100. Broadcast circuitry 902-6 and/or broadcast circuitry 904-6 may be combined with one or more features disclosed herein.

Broadcast circuitry of DPEs 104 may be individually configurable based on configuration bits stored in configuration registers of the respective DPEs. Broadcast circuitry 902-6 and/or broadcast circuitry 904-6 may, for example, be configurable to detect specified types of events that occur within core 704-6 and/or memory module 702-6. Detectable events within core 704-6 may include, without limitation, starts and/or ends of read operations by core 704-6, starts and/or ends of write operations by core 704-6, stalls, and/or other operations performed of core 704-6. Detectable events within memory module 702-6 may include, without limitation, starts and/or ends of read operations of DMA engine 844, starts and/or ends of write operations by DMA engine 844, stalls, and other operations of memory module 702-6. In other examples, broadcast circuitry 902-6 and/or broadcast circuitry 904-6 may detect specified types of events that occur within and/or in relation to DMA engine 844, MM switch 708-6, stream switch 706-6, MI 810, MI 814, CtM interface 812, CtM interface 822, CI 830, CI 832, and/or other components of DPE 104-6. Configuration registers 828 of DPE 104-6 may control which events generated by DPE 104-6 and/or which events received by broadcast circuitry 902-6 and/or 604-6, are propagated to broadcast circuitry of other DPEs. Configuration registers 828 of DPE 104-6 may control which events are propagated between broadcast circuitry 902-6 and broadcast circuitry 604-6. In an example, broadcast circuitry 902-6 generates events based on conditions within core 704-6, and broadcast circuitry 904-6 generates events based on conditions within memory module 702-6. After configuration bits are written to configuration registers 828 (i.e., via MM switch 708-6), broadcast circuitry 902-6 and/or 904-6 may operate in the background.

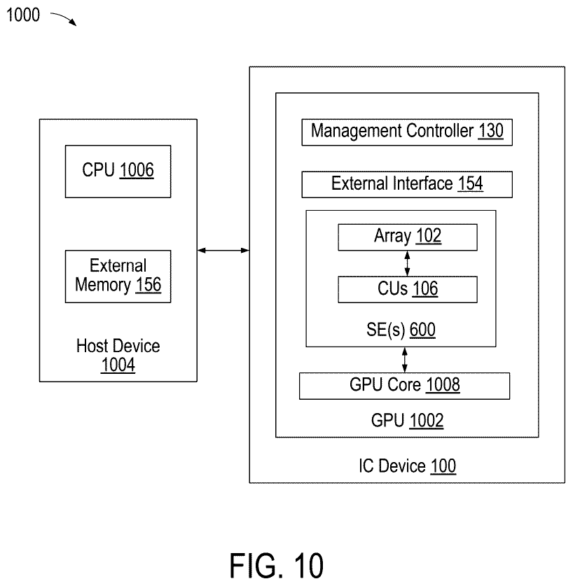

FIG. 10 depicts a system 1000 in which array 102 and CUs 106 are integrated within a graphics processing unit (GPU) 1002, according to an embodiment. In the example of FIG. 10, a host device 1004 having a central processing unit (CPU) 1006, offloads tasks to GPU 1002. A GPU core 1008 assigns shader tasks to SEs 600 for execution by SIMD processors 108, SEs 600 return results to GPU core 1008, and GPU core 1008 returns results to host device 1004.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
a data processing array comprising data processing elements (DPEs) and a network of links and configurable switches; and
a first compute unit configured to interface with a first subset of the DPEs via the network of links and switches, wherein the first compute unit comprises:
a first set of single-instruction multiple-data (SIMD) processors;
a first local data storage system (LDS); and
first synchronizing circuitry configured to control access to the first LDS by the first set of SIMD processors and the first subset of the DPEs.

2. The IC device of claim 1, wherein the first subset of DPEs is configured to exchange data with the first set of SIMD processors via the first LDS and the network of links and switches.

3. The IC device of claim 1, wherein:
DPEs of the first subset of DPEs comprise respective data memory; and
the DPEs of the first subset of DPEs are configured to exchange data with one another via the network of links and switches and the data memory of one or more of the DPEs of the first subset of DPEs.

4. The IC device of claim 1, further comprising:
a second compute unit configured to interface with a second subset of the DPEs via the network of links and switches, wherein the second compute unit comprises:
a second set of SIMD processors;
a second LDS; and
second synchronizing circuitry configured to control access to the second LDS by the second set of SIMD processors and the second subset of the DPEs.

5. The IC device of claim 4, wherein the first and second sets of SIMD processors are further configured to exchange data with one another via the network of links and switches.

6. The IC device of claim 5, wherein:
the DPEs comprise respective data memory; and
the first and second sets of SIMD processors are further configured to exchange data with one another via the network of links and switches and the local data memory of one or more of the DPEs.

7. The IC device of claim 1, wherein:
the first compute unit is configured to execute shader tasks of an application program executing on a host device.

8. A shader engine (SE), comprising:
an array of data processing elements (DPEs);
a network of links and configurable switches; and
a first compute unit configured to interface with a first subset of the DPEs, wherein the first compute unit comprises:
a first set of single-instruction multiple-data (SIMD) processors;
a first local data storage system (LDS); and
first synchronizing circuitry configured to control access to the first LDS by the first set of SIMD processors and the first subset of the DPEs.

9. The SE of claim 8, wherein:
the SIMDs are configured to execute shader tasks of an application program executing on a host device; and
the DPEs are configured to perform aspects of the shader tasks.

10. The SE of claim 8, wherein the first subset of DPEs is configured to exchange data with first set of SIMD processors via the first LDS and the network of links and switches.

11. The SE of claim 10, wherein:
DPEs of the first subset of DPEs comprise respective data memory; and
the DPEs of the first subset of DPEs are configured to exchange data with one another via the network of links and switches and the data memory of one or more of the DPEs of the first subset of DPEs.

12. The SE of claim 8, further comprising:
a second compute unit configured to interface with a second subset of the DPEs via the network of links and switches, wherein the second compute unit comprises:
a second set of SIMD processors;
a second LDS; and
second synchronizing circuitry configured to control access to the second LDS by the second set of SIMD processors and the second subset of the DPEs.

13. The SE of claim 12, wherein the first and second sets of SIMD processors are further configured to exchange data with one another via the network of links and switches.

14. The SE of claim 12, wherein:
the DPEs comprise respective data memory; and
the first and second sets of SIMD processors are further configured to exchange data with one another via the network of links and switches and the local data memory of one or more of the DPEs.

15. A graphics processing unit (GPU), comprising:
multiple integrated circuit dies, each comprising an array of data processing elements (DPEs) and first and second sets of compute units (CUs), wherein:
the first set of CUs are configured to interface with respective subsets of the DPEs as a first shader engine; and
the second set of CUs are configured to interface with respective subsets of the DPEs as a second shader engine.

16. The GPU of claim 15, wherein the CUs each comprise:
multiple single-instruction multiple-data (SIMD) processors;
a local data storage system (LDS); and
synchronizing circuitry configured to control access to the LDS by the SIMD processors and the respective subset of the DPEs.

17. The GPU of claim 16, wherein:
the SIMDs are configured to execute shader tasks of an application program executing on a host device; and
the DPEs are configured to perform aspects of the shader tasks.

18. The GPU of claim 16, wherein the subsets of the DPEs are configured to exchange data with the respective SIMD processors via the respective LDS and the network of links and switches.

19. The GPU of claim 18, wherein:
DPEs comprise respective data memory; and
the DPEs of each of the subsets of the DPEs are configured to exchange data with one another via the network of links and switches and the data memories of the DPEs of the respective subsets of the DPEs.

20. The GPU of claim 16, wherein the SIMD processors of the first and second shader engines are further configured to exchange data with one another via the network of links and switches.
